(19) United States
(12) Patent Application Publication
(10) Pub. No.: US 2006/0005914 A1
(43) Pub. Date: Jan. 12, 2006

(54) Method for machining a blank or semi-finished product of a future optical element

(76) Inventors: Norbert Blum, Huttlingen (DE); Michael Zaiser, Bobingen (DE)

Correspondence Address: D Brent Kenady;Wells St John P S, Suite 1300, 601 West First Avenue, Spokane, WA, 99201-3828, US

(21) Appl. No.: 10/529,124

(22) PCT Filed: Sep. 25, 2003
(86) PCT No.: PCT/EP03/10646

§ 371 Date: Mar. 24, 2005

(30) Foreign Application Priority Data
Sep. 27, 2002 (DE) 10245081.1

(51) Int. Cl. B32B 37/00

(52) U.S. Cl. 156/153

(57) ABSTRACT

In a method of machining a blank or a semifinished product (1) of a subsequent optical element, in particular an eyeglass lens, the blank or the semifinished product (1) is held on a surface (5) of a mounting device (3) for machining the free side of the blank or the semifinished product (1). The mounting device (3) is inserted into a holding device. An adhesive connection is introduced between the blank or the semifinished product (1) and the mounting device (3), the mounting device (3) being adapted to the radius of that surface (5) of the blank or of the semifinished product (1) which is connected to the mounting device (3).

### BACKGROUND OF THE INVENTION

1. Field of the Invention

The invention relates to a method of machining a blank or a semifinished product of a subsequent optical element, in particular an eyeglass lens, the blank or the semifinished product being held on the surface of a mounting device for machining the free side of the blank or the semifinished product, and the mounting device being inserted into a holding device.

2. Description of the Related Art

In known methods, blanks of non-individual progressive lenses are produced in a casting process. After marking of the blanks, which already have a machined surface, they are oriented at a blocking device, it being possible to then machine the free sides of the blank.

In the case of individual progressive lenses, the semifinished product is produced from a blank, which has still not been machined, in a turning, milling or grinding process and, if required, in a subsequent polishing process. In this case, it is necessary to connect the blank to a mounting device for clamping in the machine tools. This can be made possible via a blocking process, which connects the blank and the mounting device to one another. The connecting material used between the blank and the mounting device is either a low-melting metal (alloy) or wax. In the case of wax, problems and inaccuracies arise in the subsequent machining processes due to the low compressive strength of the connecting material. For eyeglass lens manufacturers who use wax, this means alloy has to be used as connecting material for the production of blanks in a machining process.

The alloy is applied in a molten state and then hardened. The thickness of the bond between the alloy connecting material and the mounting device is too small in order to be able to use higher forces during the machining process.

When wax is used as connecting material, certain residues remain after the machining of the blank or semifinished product, and these residues require intensive cleaning of the blank or semifinished product and of the mounting device. This in turn results in an extremely long machining time and high costs.

Furthermore, CN 1196994 A discloses a grinding and polishing machine for lenses. The workpiece that is machined is fixed in the grinding machine by an adhesive tape.

### SUMMARY OF THE INVENTION

Accordingly, the object of the invention is to provide a method of mounting blanks or semifinished products in machine tools which complies with the dimensional accuracy and substantially reduces the machining time and the production costs.

This object is achieved according to the invention in that an adhesive connection is introduced between the blank or the semifinished product and the mounting device, the mounting device being adapted to the radius of that surface of the blank or of the semifinished product which is connected to the mounting device.

The connecting element used is not a commercially available mounting but a mounting device adapted to the back radius of the blank or the semifinished product. The mounting device is connected to the blank or to the semifinished product via an adhesive connection, the adhesive connection advantageously being effected via a double-sided adhesive tape. A more accurate bearing surface of the workpiece or of the subsequent eyeglass lens in a collet of a machine tool is produced by the mounting device adapted to the back radius of the blank or of the semifinished product.

The adhesive connection permits higher shearing forces during the machining processes than in the case of an alloy or wax connection.

Due to the use of higher shearing forces, higher cutting speeds can be used in the method according to the invention, a factor which leads to a reduction in the machining time. Due to the adhesive connection used, no further processes for the preparation or subsequent treatment of the connecting material are necessary.

Provision may advantageously be made for the adhesive tape to be of punched and slit design.

The adhesive tape may be applied to the mounting device or to the blank or semifinished product in a punched and slit state. This avoids the formation of folds if the adhesive tape is stuck onto a, for example, convex mounting device.

Advantageous configurations and developments of the invention follow from the further subclaims and the exemplary embodiment described below in principle with reference to the drawing.

### BRIEF DESCRIPTION OF THE DRAWING

FIG. 1 shows a side view of the blank or semifinished product;

FIG. 2 shows a plan view of an adhesive tape, here in particular an adhesive pad;

FIG. 3 shows a side view of a mounting device; and

FIG. 4 shows a side view of a connection between a mounting device and a blank or a semifinished product via an adhesive connection.

### DETAILED DESCRIPTION

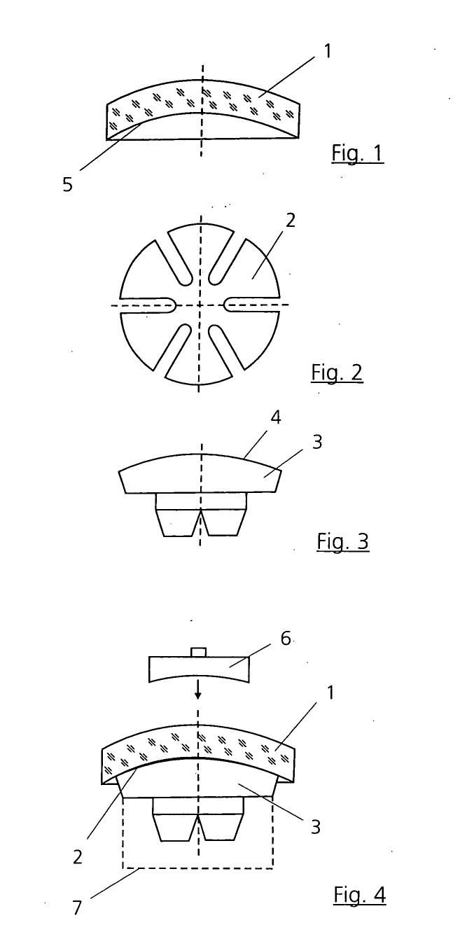

FIG. 1 shows a blank or a semifinished product 1. To begin with, the blank 1 is designed to be rotationally symmetrical before the machining steps, in which case the blank 1 may consist either of two plane-parallel plates or two spherical surfaces. If the blank 1 is produced from two spheres, this results in certain advantages with regard to shorter machining time and reduced material costs.

The blank and also the semifinished product 1 may be produced from mineral glass, from organic glass or even from polycarbonates.

The adhesive tape 2, which is shown here in FIG. 2, is designed as an adhesive pad in this exemplary embodiment. The adhesive pad 2 is advantageously of punched and slit design. This has the advantage that, when the adhesive pad 2 is stuck onto a mounting device 3, as shown here in FIG. 3, folds do not form in the adhesive tape 2 in the case of a convex design of the mounting surface 4 of the mounting device 3. The adhesive tape 2 may of course also have other embodiments, although the formation of folds should always be avoided.

The adhesive tape 2 can be applied over the full surface area, so that very high forces which hold the blank or the semifinished product 1 on a mounting device 3 are possible.

The materials for such an adhesive tape 2 are commercially available double-sided adhesive tapes which should not meet any special requirements.

FIG. 3 shows a mounting device 3 which has a mounting surface 4 which is adapted to the back radius 5 of the blank 1 or of the semifinished product 1. The large number of variants of the mounting devices 3 can be limited by standardization of the back radii of the blanks 1. Since the semifinished products 1 are cast as a rule, the front surfaces therefore already have different deflections. It would therefore be advantageous for different mounting devices to be available when using this method.

The mounting device 3 may of course also be provided with a concave mounting surface which is adapted to the front radius of the blank 1 or of the semifinished product 1. This also enables back surfaces of blanks 1 or semifinished products 1 to be machined.

The mounting device 3 adapted to the blank or semifinished product 1 improves the accuracy, in particular the subsequent surface machining. In addition, the costs are substantially reduced on account of a reduced production time and a material reduction in the blank 1.

FIG. 4 shows the completed method step when connecting the mounting device 3 to the blank or the semifinished product 1 by an adhesive connection, in particular an adhesive pad 2. In the case of new types of material for eyeglass lens production, e.g. polycarbonates, work should only be carried out with such an adhesive connection, since the alloy or wax connection becomes loose during the turning process and thus the blank or semifinished product 1 falls off from the connecting materials, such as alloy and wax.

The two surfaces 4 and 5 to which the adhesive tape 2 is connected need not be protected by lacquering or masking with a film as in a blocking process. The adhesive tape 2 can be easily and neatly removed again from the surfaces. A process step is thus omitted. Due to the adhesive connection used, no further process steps for preparation, such as, in particular, heating or subsequent treatment, such as, for example, curing of the connecting material by thermal, chemical, electrical or other energy, are necessary. Therefore further machines and devices for the processing, such as a blocker or a curing oven for example, are also not necessary. It is only necessary to insert the mounting device into a holding device 7.

Due to the accurate adaptation to the back surface 5 of the blank or semifinished product 1, the mounting device 3 gives the blank or semifinished product 1 greater stability during a turning, milling or grinding process, a factor which leads to greater dimensional accuracy of the optical surface. Due to this stabilizing effect of the mounting device 3, the blank or the semifinished product 1 can be designed to be thinner, which firstly leads to a reduction in the production costs or in the purchase price of the blanks 1 due to less use of material. Secondly, the machining times during the machining of the back surface are substantially reduced due to less material removal.

The blank or the semifinished product 1 can be applied to the mounting device 3 in the arrow direction according to FIG. 4 by means of a pressure device 6, which is not shown in any more detail here. The press may be operated mechanically, electrically or pneumatically. It is also possible to apply the mounting device 3 to the blank or the semifinished product 1 manually.

Furthermore, it is possible to use a liquid adhesive material instead of an adhesive tape 2. In the case of such a connection, it is advantageous to protect the two surfaces 4 and 5 with a protective film. Thus the liquid adhesive material can also be removed again simply and quickly by pulling off the protective film from the two surfaces 4 and 5 after the process of machining the blank or the semifinished product 1.

It is also conceivable for a synthetic resin connection to be used as adhesive connection, in which case protective films should likewise be used here for protecting the surfaces 4 and 5.

This method is especially advantageous during the production of front surfaces. The front surface can thus be produced with the greatest accuracy by machining, it being possible for an individual lens to be produced, that is to say that the patient's data are incorporated individually in the front surface. This relates in particular to progressive lenses. Irrespective of the blocking materials of a customer which are used for machining the rear side, the machining of the front surface can now be introduced here for external customers.

The method is mainly used in the freeform surfacing system for producing freeform surfaces of eyeglass lenses, in which system individual progressive lenses and standard progressive lenses are produced starting from a blank 1. That is to say that the semifinished products are not produced in a casting process but via a turning, milling or grinding process and if required via a polishing process. Of course, if necessary, other eyeglass lenses can therefore also be produced starting from a blank or a semifinished product 1.

What is claimed is:

1. A method of machining a blank or a semifinished product of a subsequent optical element, wherein said blank or said semifinished product being held with a surface on a surface of a mounting device for machining a free side of the blank or the semifinished product which is opposite to said surface of said blank or said semifinished product, wherein said mounting device being inserted into a holding device, wherein said surface of said mounting device being adapted to the radius of said surface of said blank or of said semifinished product, and wherein an adhesive connection being introduced between said surface of said blank or said semifinished product and said surface of said mounting device.

2. Method according to claim 1, wherein said surface of said blank or said semifinished product is the back surface of said blank or said semifinished product.

3. Method according to claim 1, wherein said blank or said semi finished product is used for an eyeglass lens as optical element.

4. Method according to claim 1, wherein said adhesive connection is effected via a double-sided adhesive tape.

5. Method according to claim 4, wherein said adhesive tape is of punched and slit design.

6. Method according to claim 4, wherein an adhesive pad is used as adhesive tape.

7. Method according to claim 1, wherein said adhesive connection is effected via a liquid adhesive material.

8. Method according to claim 7, wherein said mounting device is provided with a protective film before the liquid adhesive material is applied.

9. Method according to claim 7, wherein said mounting device and said blank or said semifinished product are provided with a protective film before the liquid adhesive material is applied.

10. Method according to claim 1, wherein said adhesive connection is effected by a synthetic resin connection.

11. Method according to claims 1, wherein a pressing device is used for pressing said blank or said semifinished product onto said mounting device.

12. Method according to claim 11, wherein said pressing device is operated mechanically, electrically or pneumatically.
